(19) United States
(12) Patent Application Publication
(10) Pub. No.: US 2008/0065517 A1
(43) Pub. Date: Mar. 13, 2008

(54) Determining a Technology State of an Entity Using a Technology Index

(76) Inventor: Reinier J. Aerdts, Plano, TX (US)

Correspondence Address: BAKER BOTTS L.L.P., 2001 ROSS AVENUE, 6TH FLOOR, DALLAS, TX, 75201-2980, US

(21) Appl. No.: 11/531,361

(22) Filed: Sep. 13, 2006

(51) Int. Cl. G06Q 10/00

(52) U.S. Cl. 705/28

(57) ABSTRACT

In certain embodiments, a method for determining a technology state of an entity comprises accessing information technology (IT) quantity data for an entity for a first time period. The IT quantity data comprises: (1) technology quantity data for technology components of the entity, indicating for the first time period a number of obsolete and a number of non-obsolete technology components; (2) process quantity data for processes of the entity, indicating for the first time period a number of obsolete and a number of non-obsolete processes; and (3) people quantity data for people of the entity, indicating for the first time period a number of obsolete and a number of non-obsolete people. Expenditure data for the technology components, processes, and people is accessed and comprises one or more of capital expense data and operational expense data for the first time period. A technology index for the entity is generated, according to the IT quantity data and the expenditure data, and quantifies a technology state for the entity.

### TECHNICAL FIELD OF THE INVENTION

This invention relates generally to information technology (IT) management and more particularly to determining a technology state of an entity using a technology index.

### BACKGROUND

Entities such as business enterprises generally have an associated IT infrastructure. Entities are dealing with increasing complexity of the overall IT environment. As the rate of change increases, it becomes more difficult to assess the impact of these alterations to the overall environment. Entities often buy the newest and purportedly best technology (e.g., as a first install or by upgrading), hoping to get the best new functionality and efficiency available. However, these entities have no real way of knowing how current they are in the terms of their IT environments.

### SUMMARY OF THE INVENTION

According to the present invention, disadvantages and problems associated with determining a technology state of an entity may be reduced or eliminated.

In certain embodiments, a method for determining a technology state of an entity comprises accessing information technology (IT) quantity data for an entity for a first time period. The IT quantity data comprises: (1) technology quantity data for technology components of the entity, indicating for the first time period a number of obsolete and a number of non-obsolete technology components; (2) process quantity data for processes of the entity, indicating for the first time period a number of obsolete and a number of non-obsolete processes; and (3) people quantity data for people of the entity, indicating for the first time period a number of obsolete and a number of non-obsolete people. Expenditure data for the technology components, processes, and people is accessed and comprises one or more of capital expense data and operational expense data for the first time period. A technology index for the entity is generated, according to the IT quantity data and the expenditure data, and quantifies a technology state for the entity.

Particular embodiments of the present invention may provide one or more technical advantages. In certain embodiments, the technology index may quantify the technology state of an entity. For example, in certain embodiments, the technology index may reflect, in part, the currency (e.g., non-obsolescence) of an entity's technology, providing the entity with a numeric representation of the currency of the entity's IT. In certain embodiments, the present invention enables the entity to determine the effect of changes in its technology components (e.g., hardware components and software installations) over time, which may include both the failure to change technology components or changing the technology components. In certain embodiments, the present invention allows a user to determine the potential effect of changes in technology, by playing “what-if” scenarios for example. In certain embodiments, the technology index of the present invention provides a measure of the rate of technology adoption in an entity, based on implementation and support of current and supported technology. The technology index may take into account the hardware components, software installations, the support infrastructure (e.g., the people trained and certified to manage or otherwise use the hardware components and software installations), and the supporting processes.

In certain embodiments, the technology index measures the impact of changes in technology components (e.g., hardware components and software installations), processes, and people. A weighted average may be computed using obsoleteness values for each of these categories, weighted by the expenditures in each one of these categories. This approach may provide a substantially accurate reflection of the impact of IT expenditures from a technology point of view. In certain embodiments, accounting for the annual IT expenditures in each of the categories may align more closely the generated technology index with the business value derived. The present invention may provide techniques for measuring the impact of End-of-Service Life (EOSL) and obsolete IT components. The present invention may provide techniques for measuring the technology impact of automation.

Certain embodiments of the present invention may provide some, all, or none of the above advantages. Certain embodiments may provide one or more other technical advantages, one or more of which may be readily apparent to those skilled in the art from the figures, descriptions, and claims included herein.

### BRIEF DESCRIPTION OF THE DRAWINGS

For a more complete understanding of the present invention and its advantages, reference is made to the following descriptions, taken in conjunction with the accompanying drawings, in which:

FIG. 1 illustrates an example system for determining a technology state of an entity, according to certain embodiments of the present invention;

FIG. 2 illustrates an example method for determining a technology state of an entity, according to certain embodiments of the present invention;

FIG. 3 illustrates an example method for generating a technology index, according to certain embodiments of the present invention;

FIGS. 4A-4C illustrates an example spreadsheet that may be generated according to certain embodiments of the present invention; and

FIGS. 5A-5C illustrates the example spreadsheet of FIGS. 4A-4C in greater detail.

### DESCRIPTION OF EXAMPLE EMBODIMENTS

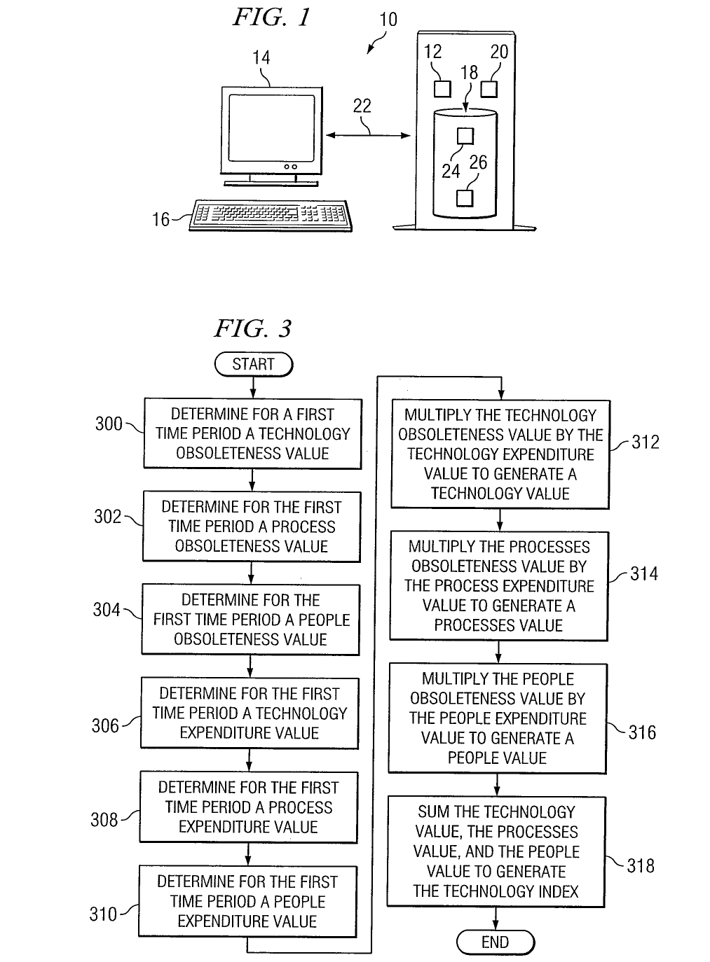

FIG. 1 illustrates an example system 10 for determining a technology state of an entity, according to certain embodiments of the present invention. System 10 includes a processing module 12, a display module 14, one or more input devices 16, one or more memory modules 18, and an index-generating application 20. Although an example implementation of system 10 is illustrated and primarily described, the present invention contemplates any suitable implementation of system 10. In general, system 10 is operable to generate a technology index for an entity, the technology index quantifying a technology state of the entity.

System 10 may include one or more computer systems at one or more locations that may share data storage, communications, or other resources according to particular needs. For example, system 10 may include a computer system, such as a personal computer (PC), which in certain embodiments might include a desktop or laptop PC. Although system 10 is described primarily as a PC, the present invention contemplates system 10 being any suitable type of computer system, according to particular needs. For example, system 10 could include a client-server system. System 10 may include any suitable input devices, output devices, mass storage media, processors, memory, or other suitable components for receiving, processing, storing, and communicating information. Furthermore, system 10 may operate using any suitable platform, according to particular needs. The operations of system 10 may be implemented in any suitable combination of software, firmware, and hardware.

Processing module 12 may include one or more processing units. Processing units may include one or more microprocessors, controllers, or any other suitable computing devices or resources. Processing module 12 may work, either alone or with other components of system 10, to provide the functionality of system 10 described herein. For example, operations performed by processing module 12 may be performed collectively by processing module 12 and memory module 22.

System 10 includes one or more display modules 14, each of which may include a computer monitor, television, projector, or any other suitable type of display device. System 10 includes one or more input devices 16, which may be used by a user of system 10 to interact with processing module 12, display module 14, and any other suitable components of system 10. Input devices 16 may include a keyboard, a mouse, or any other suitable input devices. Although particular input devices 16 are illustrated and described, the present invention contemplates system 10 receiving input from a user in any suitable manner. For example, display device 14 may include touch-screen capabilities. As another example, one or more applications running on processing module 12 may interact with system 10 to interactively select certain inputs. As yet another example, system 10 may include voice recognition capabilities such that a user of system 10 may speak into an input device 16 (e.g., a microphone) to input commands or data.

System 10 may include or otherwise be associated with one or more memory modules 18. Each memory module 18 may take the form of volatile or non-volatile memory including, without limitation, magnetic media, optical media, random access memory (RAM), read-only memory (ROM), removable media, or any other suitable memory component. In certain embodiments, memory module 18 comprises one or more databases, such as one or more Structured Query Language databases or any other suitable types of databases. Memory module 18 may be local to or remote from the one or more processing units 12 of system 10.

The components of system 10, such as processing module 12, display module 14, input devices 16, and memory module 18 may be local to or geographically remote from one another, according to particular needs. For example, processing module 12 may be geographically remote from display module 14 and/or input devices 16. The components of system 10 may communicate with one another, either directly or indirectly, using a communication link 22. In certain embodiments, communication link 22 may include one or more computer buses, local area networks (LANs), metropolitan area networks (MANs), wide area networks (WANs), a global computer network such as the Internet, or any other wireline, optical, wireless, or other links.

An entity's IT may be viewed as three categories—a technology category, a processes category, and a people category. The technology category may include one or more of the hardware components and software installations of the entity, each of which may be viewed as its own category of IT if appropriate. For example, the technology category may include the various pieces of hardware that reside on a company's computer network (e.g., the one or more servers, the one or more client computers, the one or more routers, or other suitable hardware), and the various software applications used to run the environment or used by the employees to perform their jobs. The hardware components and software installations of the entity may be viewed at any suitable level of granularity, according to particular needs. The processes category may include the processes that are being used by the entity and implemented using one or more of the technology components of the entity. In certain embodiments, these processes are based on relevant industry standards. The people category may include any suitable the people who are trained to use, manage, maintain, or otherwise interact with the technology components of the entity. For example, the people category may include the people who are trained and certified to run the technology components of the entity. The people may include employees of the company, third parties (e.g., vendors or service providers), or any other suitable people. In certain embodiments, this view of an entity's IT is driven by the Information Technology Infrastructure Library (ITIL). Although this particular implementation is primarily described, the present invention contemplates categorizing the IT of an entity in any other suitable manner, according to particular needs.

Memory module 18 may store IT quantity data 24 and expenditure data 26 for the entity. IT quantity data 24 may include technology quantity data for one or more technology components of the entity, process quantity data for one or more processes of the entity, and people quantity data for one or more people of the entity. The technology quantity data may indicate a number of technology components of the entity. As described above, the technology components may include one or more hardware components and one or more software installations of the entity. Technology quantity data may include one or more of hardware quantity data and software quantity data. Hardware quantity data indicates a number of hardware components of the entity, and software quantity data indicates a number of software installations of the entity. Process quantity data indicates a number of processes of the entity. People quantity data indicates a number of people of the entity.

IT quantity data 24 may indicate the number of IT components of the entity that are obsolete and the number of IT components of the entity that are non-obsolete. For example, technology quantity data may indicate the number of technology components of the entity that are obsolete and the number of technology components of the entity that are non-obsolete. As a particular example, hardware quantity data may indicate the number of hardware components of the entity that are obsolete and the number of hardware components of the entity that are non-obsolete, and software quantity date may indicate the number of software installations of the entity that are obsolete and the number of software installations of the entity that are non-obsolete. As another example, process quantity data may indicate the number of processes of the entity that are obsolete and the number of processes of the entity that are non-obsolete. As another example, people quantity data may indicate the number of people of the entity that are obsolete and the number of people of the entity that are non-obsolete.

Whether a particular technology component (i.e., hardware component or software installation) should be classified as obsolete or non-obsolete may be determined in any suitable manner, according to particular needs. Factors such as whether the vendor of the technology component still offers a service plan for the technology component, industry standards, whether the technology component is older than a predetermined number of years, or other suitable factors may be used, either alone or in combination, in determining whether the technology component should be classified as obsolete or non-obsolete.

In certain embodiments, whether a particular process should be classified as obsolete or non-obsolete may depend on how the technology component supported by the process is classified. For example, if a particular process supports a technology component that is classified as obsolete, then the process may also be classified as obsolete. As another example, if a particular process supports a technology component that is classified as non-obsolete, then the process may also be classified as non-obsolete. Additionally or alternatively, any other suitable factors may be used, either alone or in combination, in determining whether the process should be classified as obsolete or non-obsolete. In certain embodiments, if a particular process supports both obsolete and non-obsolete technology components, then the particular process may be classified as obsolete; however, the present invention contemplates classifying the particular process as non-obsolete.

Similarly, in certain embodiments, whether a particular person should be classified as obsolete or non-obsolete may depend on how the technology component or process supported by the person is classified. For example, if a particular person supports a technology component that is classified as obsolete, then the person may also be classified as obsolete. As another example, if a particular person supports a technology component that is classified as non-obsolete, then the person may also be classified as non-obsolete. Additionally or alternatively, any other suitable factors may be used, either alone or in combination, in determining whether the process should be classified as obsolete or non-obsolete. In certain embodiments, if a particular person supports both obsolete and non-obsolete technology components or processes, then the particular person may be classified as obsolete; however, the present invention contemplates classifying the particular person as non-obsolete.

Although particular techniques for determining whether technology components, processes, and people should be classified as obsolete or non-obsolete are primarily described, the present invention contemplates determining whether technology components, processes, and people should be classified as obsolete or non-obsolete in any suitable manner, according to particular needs.

It should be understood that each and every hardware component, software installation, process, and person in the entity may not necessarily be accounted for in the hardware quantity data, software quantity data, process quantity data, and people quantity data. Any suitable criteria may be used for determining which hardware components, software installations, processes, and people to account for in the hardware quantity data, software quantity data, process quantity data, and people quantity data, respectively. Factors such as industry standards, individual entity goals, or other suitable factors may be used in determining which hardware components, software installations, processes, and people to include. In certain embodiments, the technology components (i.e., the hardware and software installations) are determined first, and then the processes and people associated with those technology components are determined.

IT quantity data 24 may be specified for one or more time periods. For example, a first set of IT quantity data 24 may be specified for a first time period (e.g., year zero), a second set of IT quantity data 24 may be specified for a second time period (e.g., year one), a third set of IT quantity data 24 may be specified for a third time period (e.g., year two), and so on. IT quantity data 24 may be determined and stored at any suitable time interval, according to particular needs.

Expenditure data 26 may include expenditure data for each of the components accounted for in IT quantity data 24. In certain embodiments, expenditure data 26 may include expenditure data for the one or more technology components (i.e., hardware components and software installations), the one or more processes, and the one or more people of the entity. As a first example, expenditure data 26 for the one or more hardware components of the entity may include the capital expenditures and operational expenditures incurred (or projected) for the one or more hardware components for the relevant time period. The relevant time period may include the time period to which IT quantity data 24 corresponds. As a second example, expenditure data 26 for the one or more software installations of the entity may include the capital expenditures and operational expenditures incurred (or projected) for the one or more hardware components for the relevant time period. As a third example, expenditure data 26 for the one or more processes of the entity may include the operational expenditures incurred (or projected) for the one or more processes for the relevant time period. As a fourth example, expenditure data 26 for the one or more people of the entity may include the operational expenditures incurred (or projected) for the one or more people for the relevant time period.

System 10 may include index-generating application 20, which may include any suitable combination of software, firmware, and hardware. In certain embodiments, portions or all of index-generating application 20 may be implemented using MICROSOFT EXCEL or another suitable spreadsheet program; however, the present invention is not intended to be so limited. In certain embodiments, index-generating application 20 is operable to generate a technology index for the entity using at least a portion of IT quantity data 24 and expenditure data 26. The technology index may allow a technology state of the entity to be determined. For example, the technology index may quantify the technology state of an entity for a particular time period.

In general, the technology index comprises a weighted average of the non-obsoleteness of each of the IT categories weighted by the amount spent for each of the IT categories of the entity (e.g., hardware components, software installations, processes, and people). The technology index may be generated by determining, for each IT category (e.g., hardware components, software installations, processes, and people), the percentage that is non-obsolete. Each percentage may then be weighted by the percentage of total IT expenditures for which that category is responsible, and summing those results across all categories. Although these particular categories (i.e., technology components (hardware components and software installations), processes, and people) are primarily described, the present invention contemplates using any suitable categories for generating a technology index for an entity.

To set up generating a technology index for an entity for a first time period, IT quantity data 24 for the entity for the first time period may be determined and stored. The number of technology components of the entity for a first time period may be determined. In certain embodiments, the technology components of an entity include the hardware components and software installations of the entity. For example, the number of hardware components of the entity and the number of software installations of the entity may be determined. The technology components need not include all hardware components and software installations of the entity, and the determination of which to include may be made in any suitable manner and according to any suitable criteria. The first time period may include any suitable time period, according to particular needs.

The number of technology components that are obsolete and the number of technology components that are non-obsolete may be determined for the first time period. For example, the number of hardware components that are obsolete and the number of hardware components that are non-obsolete may be determined, and the number of software installations that are obsolete and the number of software installations that are non-obsolete may be determined. Whether a particular technology component (e.g., hardware component or software installation) is obsolete or non-obsolete may be determined in any suitable manner, according to particular needs.

Technology quantity data may be stored. Technology quantity data may include one or more of the total number of technology components of the entity (e.g., the sum of the total number of hardware components and the total number of software installations), the number non-obsolete technology components, the number of obsolete technology components, and any other suitable information. In certain embodiments, storing the technology quantity data includes entering all or a portion of the technology quantity data into a spreadsheet. In embodiments in which the one or more technology components of the entity include one or more hardware components and one or more software installations, the technology quantity data may indicate a number of obsolete hardware components of the entity, a number of non-obsolete hardware components of the entity, a number of obsolete software installations of the entity, and a number of non-obsolete software installations of the entity.

The number of processes of the entity for the first time period may be determined. The processes need not include all processes of the entity, and the determination of which to include may be made in any suitable manner and according to any suitable criteria. In certain embodiments, the processes of the entity that are counted include the processes that support the technology components.

The number of the processes that are non-obsolete and the number of the processes that are obsolete may be determined for the first time interval. In certain embodiments, the non-obsolete processes include the processes that support non-obsolete technology components and the obsolete processes include the processes that support obsolete technology components; however, the present invention contemplates determining the number of non-obsolete processes and the number of obsolete processes in any suitable manner according to particular needs.

Process quantity data may be stored. The process quantity data may include one or more of the total number of processes of the entity (e.g., the total number of processes that support the technology components of the entity), the number non-obsolete processes, the number of obsolete processes, and any other suitable information. In certain embodiments, storing the process quantity data includes entering all or a portion of the process quantity data into a spreadsheet.

The number of people of the entity for the first time period may be determined. The people need not include all people of the entity, and the determination of which to include may be made in any suitable manner and according to any suitable criteria. In certain embodiments, the people of the entity that are counted include the people that support the technology components.

The number of people who are non-obsolete and the number of people who are obsolete may be determined for the first time period. In certain embodiments, the non-obsolete people may include people who support non-obsolete technology components or processes and the obsolete people may include the people who support obsolete technology components or processes; however, the present invention contemplates determining the number of non-obsolete people and the number of obsolete people in any suitable manner according to particular needs.

People quantity data may be stored. The people quantity data may include one or more of the total number of people of the entity (e.g., the total number of people who support the technology components of the entity), the number non-obsolete people, the number of obsolete people, and any other suitable information. In certain embodiments, storing the people quantity data includes entering all or a portion of the people quantity data into a spreadsheet.

Expenditure data 26 for the entity may be determined for the first time period. Expenditure data 26 may include expenditure data for each of the components accounted for in IT quantity data 24. In certain embodiments, expenditure data 26 may include expenditure data for the one or more technology components (i.e., hardware components and software installations), the one or more processes, and the one or more people of the entity. As a first example, expenditure data 26 for the one or more hardware components of the entity may include the capital expenditures and operational expenditures incurred (or projected) for the one or more hardware components for the relevant time period. The relevant time period may include the time period to which IT quantity data 24 corresponds. As a second example, expenditure data 26 for the one or more software installations of the entity may include the capital expenditures and operational expenditures incurred (or projected) for the one or more hardware components for the relevant time period. As a third example, expenditure data 26 for the one or more processes of the entity may include the operational expenditures incurred (or projected) for the one or more processes for the relevant time period. As a fourth example, expenditure data 26 for the one or more people of the entity may include the operational expenditures incurred (or projected) for the one or more people for the relevant time period.

Once IT quantity data 24 and expenditure data 26 have been determined (and possibly stored in memory module 18) (e.g., by being entered into a spreadsheet), a technology index for the entity may be generated based on the stored data. Index-generating application 20 may be operable to perform portions or all of the functionality associated with generating the technology index. Additionally or alternatively, a user or other component of system 10 may perform certain steps or otherwise interact with system 10 to facilitate generation of the technology index.

In operation of an example embodiment of system 10, IT quantity data 24 for the entity for the first time period may be accessed. The technology quantity data for the entity for the first time period may be accessed. In certain embodiments, this may include accessing one or more of hardware quantity data and software quantity data for the entity for the first time period. The process quantity data for the entity for the first time period may be accessed. The people quantity data for the entity for the first time period may be accessed. Expenditure data 26 for the entity for the first time period may be accessed. In certain embodiments, index-generating application 20 may perform this accessing of IT quantity data 24 and expenditure data 26. For example, MICROSOFT EXCEL or another suitable spreadsheet program may perform this accessing of IT quantity data 24 and expenditure data 26.

A technology index for the entity for the first time period may be generated according to the accessed IT quantity data 24 and expenditure data 26. The technology index for the entity quantifies the technology state of the entity. In certain embodiments, index-generating application 20 may generate the technology index. For example, MICROSOFT EXCEL or another suitable spreadsheet program may generate the technology index.

In certain embodiments, the technology index may be generated in the following manner. A technology obsoleteness value for the first time period may be determined. In certain embodiments, the technology obsoleteness value is determined by dividing the number of non-obsolete technology components by a total number of technology components. The total number of technology components may include the sum of the number of non-obsolete and obsolete technology components. In certain embodiments, rather than determining a single technology obsoleteness value, a hardware obsoleteness value and a software obsoleteness value may be determined. For example, the hardware obsoleteness value may be determined by dividing the number of non-obsolete hardware components by a total number of hardware components, and the software obsoleteness value may be determined by dividing the number of non-obsolete software installations by a total number of software installations. The total number of hardware components may include the sum of the number of non-obsolete and obsolete hardware components, and the total number of software installations may include the sum of the number of non-obsolete and obsolete software installations.

A process obsoleteness value for the first time period may be determined. In certain embodiments, the process obsoleteness value may be determined by dividing the number of non-obsolete processes by a total number of processes of the entity. The total number of processes may include the sum of the number of non-obsolete and obsolete processes.

A people obsoleteness value for the first time period may be determined. In certain embodiments, the people obsoleteness value may be determined by dividing the number of non-obsolete people by a total number of people of the entity. The total number of people may include the sum of the number of non-obsolete and obsolete people.

Technology expenditures for the first time period may be determined. Technology expenditures for the first time period may be determined by summing capital expenditures for the first time period and operational expenditures for the first time period for the one or more technology components of the entity. As a first example, expenditure data 26 for the one or more hardware components of the entity may include the capital expenditures and operational expenditures incurred (or projected) for the one or more hardware components for the relevant time period. The relevant time period may include the time period to which IT quantity data 24 corresponds. As a second example, expenditure data 26 for the one or more software installations of the entity may include the capital expenditures and operational expenditures incurred (or projected) for the one or more hardware components for the relevant time period.

The process expenditures for the first time period may be determined. In certain embodiments, the processes expenditure for the first time period may be equal to the operational expenditures for the one or more processes of the entity. At step 310, the people expenditures for the first time period may be determined. In certain embodiments, the people expenditure for the first time period may be equal to the operational expenditures for the one or more people of the entity.

The total expenditures for the entity for the first time period may be determined. In certain embodiments, the total expenditures for the entity for the first time period are determined by summing the technology expenditures (e.g., hardware expenditures and software expenditures), the process expenditures, and the people expenditures for the first time period.

A technology expenditure value for the first time period may be determined. The technology expenditure value may be determined by dividing the technology expenditures by the total expenditures for the entity. In certain embodiments, rather than determining a single technology expenditure value, a hardware expenditure value and a software expenditure value may be determined. For example, the hardware expenditure value may be determined by dividing the hardware expenditures by the total expenditures for the entity, and the software expenditure value may be determined by dividing the software expenditures by the total expenditures for the entity. A process expenditure value for the first time period may be determined. In certain embodiments, the process expenditure value is determined by dividing the processes expenditures by the total expenditures for the entity. A people expenditure value for the first time period may be determined. In certain embodiments, the people expenditure value is determined by dividing the people expenditures by the total expenditures for the entity.

The technology obsoleteness value may be multiplied by the technology expenditure value to generate a technology value. In certain embodiments, rather than generated a single technology value, a hardware value and a software value may be generated. For example, the hardware value may be generated by multiplying the hardware obsoleteness value by the hardware expenditure value, and the software value may be generated by multiplying the software obsoleteness value by the software expenditure value. The process obsoleteness value may be multiplied by the process expenditure value to generate a processes value. The people obsoleteness value may be multiplied by the people expenditure value to generate a people value. The technology value, the processes value, and the people value may be summed to generate the technology index. In certain embodiments, the technology index may be calculated by summing the hardware value, the software value, the process value, and the people value. In certain embodiments, the sum of the technology value (e.g., the hardware value and the software value), the process value, and the people value may be multiplied by one hundred such that the generated technology index is expressed as a percentage.

In certain embodiments, a formula for calculating a technology index for an entity may be expressed as follows:

$$TI = ( \frac{{QT}_{non}}{{QT}_{tot}} ) ( \frac{{EXP}_{tech}}{{EXP}_{tot}} ) + ( \frac{{QPR}_{non}}{{QPR}_{tot}} ) ( \frac{{EXP}_{pr}}{{EXP}_{tot}} ) + ( \frac{{QPE}_{non}}{{QPE}_{tot}} ) ( \frac{{EXP}_{pe}}{{EXP}_{tot}} )$$

In certain embodiments, such as embodiments in which data for the one or more technology components is separated into data for one or more hardware components and data for one or more software components, the formula for calculating the technology index for an entity may be expressed as follows:

$$TI = ( \frac{{QHW}_{non}}{{QHW}_{tot}} ) ( \frac{{EXP}_{hw}}{{EXP}_{tot}} ) + ( \frac{{QSW}_{non}}{{QSW}_{tot}} ) ( \frac{{EXP}_{sw}}{{EXP}_{tot}} ) + ( \frac{{QPR}_{non}}{{QPR}_{tot}} ) ( \frac{{EXP}_{pr}}{{EXP}_{tot}} ) + ( \frac{{QPE}_{non}}{{QPE}_{tot}} ) ( \frac{{EXP}_{pe}}{{EXP}_{tot}} )$$

The variables in the above-described formulas may be defined as follows:

QTₙₒₙ=number of non-obsolete technology components;

QTₜₒₜ=total number of technology components;

QHWₙₒₙ=number of non-obsolete hardware components;

QHWₜₒₜ=total number of hardware components;

QSWₙₒₙ=number of non-obsolete software installations;

QSWₜₒₜ=total number of software installations;

QPRₙₒₙ=number of non-obsolete processes;

QPRₜₒₜ=total number of processes;

QPEₙₒₙ=number of non-obsolete people;

QPEₜₒₜ=total number of people;

EXP_{tech}=total technology expenditures;

EXP_{hw}=total hardware expenditures;

EXP_{sw}=total software expenditures;

EXPₚᵣ=total process expenditures;

EXPₚₑ=total people expenditures;

EXPₜₒₜ=total expenditures; and

TI=technology index.

In certain embodiments, the technology index may be presented as either a raw decimal value in the range 0≦technology index≦1, or as a percentage in the range 0%≦technology index≦100% (i.e., by multiplying the raw decimal value by one hundred). In certain embodiments, a technology index equal to zero (or 0%) reflects a non-standardized IT environment of obsolete technology, and a technology index equal to one (or 100%). reflects a standardized IT environment of non-obsolete technology. For example, this may be the case when: the technology obsoleteness value is generated by dividing the number of non-obsolete technology components by the total number of technology components; the process obsoleteness value is generated by dividing the number of non-obsolete processes by the total number of processes; and the people obsoleteness value is generated by dividing the number of non-obsolete people by the total number of people. Alternatively, in certain embodiments, a technology index equal to zero (or 0%) reflects a standardized IT environment of non-obsolete technology, and a technology index equal to one (or 100%) reflects a non-standardized IT environment of obsolete technology. This may be the case when: the technology obsoleteness value is generated by dividing the number of obsolete technology components by the total number of technology components; the process obsoleteness value is generated by dividing the number of obsolete processes by the total number of processes; and the people obsoleteness value is generated by dividing the number of obsolete people by the total number of people. For the remainder of this description, it will be assumed for simplicity of description that a technology index equal to zero (or 0%) reflects a non-standardized IT environment of obsolete technology, and a technology index equal to one (or 100%) reflects a standardized IT environment of non-obsolete technology.

In certain embodiments, the generated technology index represents the technology state of the entity for the first time period. A technology index may be generated for the entity at regular or other suitable intervals (e.g., a second time period, a third time period, and so on), which may build a historical data set of technology indices for the entity. In certain embodiments, a technology index may be generated for a second time period, according to IT quantity data and expenditure data for the second time period. The relationship between the technology index for the first time period and the technology index for the second time period may provide an indication of the change in the technology state for the entity over time (e.g., from the first time period to the second time period).

Thus, the technology index may allow an entity to track the impact of technology changes and provide a quantitative impact for these changes. In certain embodiments, if an entity buys new technology components or upgrades existing technology components, then the technology index for the entity may increase. For example, as hardware components and software installations of an entity are replaced with newer hardware components and software installations (i.e., become less obsolete), the technology obsoleteness value (e.g., the hardware obsoleteness value and/or the software obsoleteness value) may rise, which may drive up the technology index. Moreover, these newer technology components may require less obsolete people to maintain or otherwise use these technology components and may be less expensive to maintain, which may further drive up the technology index. If the entity does not change any of its technology components over time, then the technology index may fall. For example, as the hardware components and software installations of an entity age (i.e., become more obsolete), the technology obsoleteness value (e.g., the hardware obsoleteness value and/or the software obsoleteness value) may fall, which may drive down the technology index. Moreover, these aging technology components may require more obsolete people to maintain or otherwise use these technology components and may be more expensive to maintain, which may further drive down the technology index.

In certain embodiments, each time a technology index is generated, it may be determined whether the technology index has a predefined relationship with a predetermined threshold for the technology index. In certain embodiments, if it is determined that the technology index has the predefined relationship with the predetermined threshold, then an alert may be generated. As just one example, in embodiments in which a technology index equal to zero (or 0%) reflects a non-standardized IT environment of obsolete technology and a technology index equal to one (or 100%) reflects a standardized IT environment of non-obsolete technology, it may be determined whether the technology index is less than a predetermined threshold (e.g., which may indicate that the IT of the entity is too outdated and/or expensive to maintain). In this example, if it is determined that the technology index is below the predetermined threshold, then an alert may be generated. The alert may be communicated to any suitable person, such as an IT manager of the entity, the chief technology officer of the entity, a consultant of the entity, or any other suitable individuals or destinations.

In certain embodiments, a predictive technology index may be generated, which may allow a user to play “what-if” scenarios to determine the impact of taking certain action (or not taking certain action) with respect to the IT of the entity. For example, the predictive technology index may allow the entity to determine the effect of upgrading a particular server. The predictive technology index may be generated according to modified IT quantity data 24 and modified expenditure data 26. As an example, the relationship between the technology index for the first time period and the predictive technology index may provide an indication of the change in the technology state for the entity based on future modifications to the IT of the entity.

Particular embodiments of the present invention may provide one or more technical advantages. In certain embodiments, the technology index may quantify the technology state of an entity. For example, in certain embodiments, the technology index may reflect, in part, the currency (e.g., non-obsolescence) of an entity's technology, providing the entity with a numeric representation of the currency of the entity's IT. In certain embodiments, the present invention enables the entity to determine the effect of changes in its technology components (e.g., hardware components and software installations) over time, which may include both the failure to change technology components or changing the technology components. In certain embodiments, the present invention allows a user to determine the potential effect of changes in technology, by playing “what-if” scenarios for example. In certain embodiments, the technology index of the present invention provides a measure of the rate of technology adoption in an entity, based on implementation and support of current and supported technology. The technology index may take into account the hardware components, software installations, the support infrastructure (e.g., the people trained and certified to manage or otherwise use the hardware components and software installations), and the supporting processes.

In certain embodiments, the technology index measures the impact of changes in technology components (e.g., hardware components and software installations), processes, and people. A weighted average may be computed using obsoleteness values for each of these categories, weighted by the expenditures in each one of these categories. This approach may provide a substantially accurate reflection of the impact of IT expenditures from a technology point of view. In certain embodiments, accounting for the annual IT expenditures in each of the categories may align more closely the generated technology index with the business value derived. The present invention may provide techniques for measuring the impact of end-of-service life (EOSL) and obsolete IT components. The present invention may provide techniques for measuring the technology impact of automation.

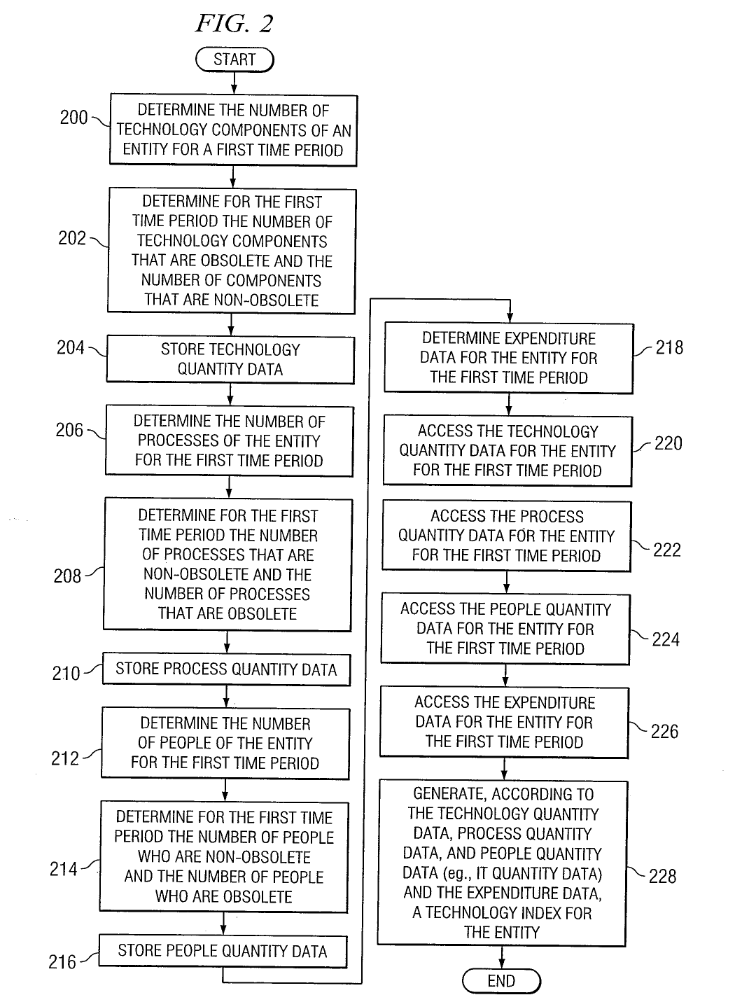

FIG. 2 illustrates an example method for determining a technology state of an entity, according to certain embodiments of the present invention. In certain embodiments, a portion or all of the method described with reference to FIG. 2 may be performed using system 10. Additionally, the present invention contemplates one or more steps of the method described with reference to FIG. 2 being performed manually, by one or more human users (with or without using system 10) for example.

At steps 200-216, IT quantity data for the entity for a first time period may be determined and stored. At step 200, the number of technology components of the entity for a first time period may be determined. In certain embodiments, the technology components of an entity include the hardware components and software installations of the entity. For example, the number of hardware components of the entity and the number of software installations of the entity may be determined. The technology components need not include all hardware components and software installations of the entity, and the determination of which to include may be made in any suitable manner and according to any suitable criteria. The first time period may include any suitable time period, according to particular needs.

At step 202, the number of technology components that are obsolete and the number of technology components that are non-obsolete may be determined for the first time period. For example, the number of hardware components that are obsolete and the number of hardware components that are non-obsolete may be determined, and the number of software installations that are obsolete and the number of software installations that are non-obsolete may be determined. As described above, whether a particular technology component (e.g., hardware component or software installation) is obsolete or non-obsolete may be determined in any suitable manner, according to particular needs.

At step 204, technology quantity data may be stored. As described above, technology quantity data may include one or more of the total number of technology components of the entity (e.g., the sum of the total number of hardware components and the total number of software installations), the number non-obsolete technology components, the number of obsolete technology components, and any other suitable information. In certain embodiments, storing the technology quantity data includes entering all or a portion of the technology quantity data into a spreadsheet. In embodiments in which the one or more technology components of the entity include one or more hardware components and one or more software installations, the technology quantity data may indicate a number of obsolete hardware components of the entity, a number of non-obsolete hardware components of the entity, a number of obsolete software installations of the entity, and a number of non-obsolete software installations of the entity.

At step 206, the number of processes of the entity for the first time period may be determined. The processes need not include all processes of the entity, and the determination of which to include may be made in any suitable manner and according to any suitable criteria. In certain embodiments, the processes of the entity that are counted include the processes that support the technology components determined at step 200.

At step 208, the number of the processes that are non-obsolete and the number of the processes that are obsolete may be determined for the first time interval. In certain embodiments, the non-obsolete processes include the processes that support non-obsolete technology components (e.g., as determined at step 202) and the obsolete processes include the processes that support obsolete technology components (e.g., as determined at step 202); however, the present invention contemplates determining the number of non-obsolete processes and the number of obsolete processes in any suitable manner according to particular needs.

At step 210, process quantity data may be stored. As described above, the process quantity data may include one or more of the total number of processes of the entity (e.g., the total number of processes that support the technology components of the entity), the number non-obsolete processes, the number of obsolete processes, and any other suitable information. In certain embodiments, storing the process quantity data includes entering all or a portion of the process quantity data into a spreadsheet.

At step 212, the number of people of the entity for the first time period may be determined. The people need not include all people of the entity, and the determination of which to include may be made in any suitable manner and according to any suitable criteria. The people of the entity may include employees of the company, third parties (e.g., vendors, service providers, etc.), or any other suitable people. In certain embodiments, the people of the entity that are counted include the people that support the technology components determined at step 200.

At step 214, the number of people who are non-obsolete and the number of people who are obsolete may be determined for the first time period. In certain embodiments, the non-obsolete people may include people who support non-obsolete technology components (e.g., as determined at step 202) and the obsolete people may include the people who support obsolete technology components (e.g., as determined at step 202); however, the present invention contemplates determining the number of non-obsolete people and the number of obsolete people in any suitable manner according to particular needs.

At step 216, people quantity data may be stored. As described above, the people quantity data may include one or more of the total number of people of the entity (e.g., the total number of people who support the technology components of the entity), the number non-obsolete people, the number of obsolete people, and any other suitable information. In certain embodiments, storing the people quantity data includes entering all or a portion of the people quantity data into a spreadsheet.

At step 218, expenditure data 26 for the entity may be determined for the first time period. Expenditure data 26 may include expenditure data for each of the components accounted for in IT quantity data 24 determined at steps 200-216. In certain embodiments, expenditure data 26 may include expenditure data for the one or more technology components (i.e., hardware components and software installations), the one or more processes, and the one or more people of the entity. As a first example, expenditure data 26 for the one or more hardware components of the entity may include the capital expenditures and operational expenditures incurred (or projected) for the one or more hardware components for the relevant time period. The relevant time period may include the time period to which IT quantity data 24 corresponds. As a second example, expenditure data 26 for the one or more software installations of the entity may include the capital expenditures and operational expenditures incurred (or projected) for the one or more hardware components for the relevant time period. As a third example, expenditure data 26 for the one or more processes of the entity may include the operational expenditures incurred (or projected) for the one or more processes for the relevant time period. As a fourth example, expenditure data 26 for the one or more people of the entity may include the operational expenditures incurred (or projected) for the one or more people for the relevant time period.

At steps 220-224, IT quantity data 24 for the entity for a first time period may be accessed. At step 220, the technology quantity data for the entity for the first time period may be accessed. In certain embodiments, this may include accessing one or more of hardware quantity data and software quantity data for the entity for the first time period. At step 222, the process quantity data for the entity for the first time period may be accessed. At step 224, the people quantity data for the entity for the first time period may be accessed. At step 226, expenditure data 26 for the entity for the first time period may be accessed. In certain embodiments, technology-index-generating application 20 may perform the accessing of steps 220-226. For example, MICROSOFT EXCEL or another suitable spreadsheet program may perform the accessing of steps 220-226.

At step 228, a technology index for the entity may be generated according to IT quantity data 24 and expenditure data 26. The technology index for the entity quantifies the technology state of the entity. In certain embodiments, the technology index may be generated using the method described below with reference to FIG. 3. In certain embodiments, technology-index-generating application 20 may generate the technology index. For example, MICROSOFT EXCEL or another suitable spreadsheet program may generate the technology index.

FIG. 3 illustrates an example method for generating a technology index, according to certain embodiments of the present invention. In certain embodiments, a portion or all of the method described with reference to FIG. 3 may be performed using system 10. For example, MICROSOFT EXCEL or another suitable spreadsheet program may generate the technology index. Additionally, the present invention contemplates one or more steps of the method described with reference to FIG. 3 being performed manually, by one or more human users (with or without using system 10) for example. In certain embodiments, technology-index-generating application 20 may generate the technology index.

At step 300, a technology obsoleteness value for the first time period may be determined. In certain embodiments, the technology obsoleteness value is determined by dividing the number of non-obsolete technology components by a total number of technology components. The total number of technology components may include the sum of the number of non-obsolete and obsolete technology components. In certain embodiments, rather than generating a single technology obsoleteness value, a hardware obsoleteness value and a software obsoleteness value may be determined. For example, the hardware obsoleteness value may be determined by dividing the number of non-obsolete hardware components by a total number of hardware components, and the software obsoleteness value may be determined by dividing the number of non-obsolete software installations by a total number of software installations. The total number of hardware components may include the sum of the number of non-obsolete and obsolete hardware components, and the total number of software installations may include the sum of the number of non-obsolete and obsolete software installations.

At step 302, a process obsoleteness value for the first time period may be determined. In certain embodiments, the process obsoleteness value may be determined by dividing the number of non-obsolete processes by a total number of processes of the entity. The total number of processes may include the sum of the number of non-obsolete and obsolete processes.

At step 304, a people obsoleteness value for the first time period may be determined. In certain embodiments, the people obsoleteness value may be determined by dividing the number of non-obsolete people by a total number of people of the entity. The total number of people may include the sum of the number of non-obsolete and obsolete people.

At step 306, technology expenditures for the first time period may be determined. Technology expenditures for the first time period may be determined by summing capital expenditures for the first time period and operational expenditures for the first time period for the one or more technology components of the entity. As a first example, expenditure data 26 for the one or more hardware components of the entity may include the capital expenditures and operational expenditures incurred (or projected) for the one or more hardware components for the relevant time period. The relevant time period may include the time period to which IT quantity data 24 corresponds. As a second example, expenditure data 26 for the one or more software installations of the entity may include the capital expenditures and operational expenditures incurred (or projected) for the one or more hardware components for the relevant time period.

At step 308, the process expenditures for the first time period may be determined. In certain embodiments, the processes expenditure for the first time period may be equal to the operational expenditures for the one or more processes of the entity. At step 310, the people expenditures for the first time period may be determined. In certain embodiments, the people expenditure for the first time period may be equal to the operational expenditures for the one or more people of the entity.

At step 312, the total expenditures for the entity for the first time period may be determined. In certain embodiments, the total expenditures for the entity for the first time period are determined by summing the technology expenditures (i.e., determined at step 306) (e.g., hardware expenditures and software expenditures), the process expenditures (i.e., determined at step 308), and the people expenditures (i.e., determined at step 310) for the first time period.

At step 314, a technology expenditure value for the first time period may be determined. The technology expenditure value may be determined by dividing the technology expenditures by the total expenditures for the entity. In certain embodiments, rather than determining a single technology expenditure value, a hardware expenditure value and a software expenditure value may be determined. For example, the hardware expenditure value may be determined by dividing the hardware expenditures by the total expenditures for the entity, and the software expenditure value may be determined by dividing the software expenditures by the total expenditures for the entity. At step 316, a process expenditure value for the first time period may be determined. In certain embodiments, the process expenditure value is determined by dividing the processes expenditures by the total expenditures for the entity. At step 318, a people expenditure value for the first time period may be determined. In certain embodiments, the people expenditure value is determined by dividing the people expenditures by the total expenditures for the entity.

At step 320, the technology obsoleteness value may be multiplied by the technology expenditure value to generate a technology value. In certain embodiments, rather than generated a single technology value, a hardware value and a software value may be generated. For example, the hardware value may be generated by multiplying the hardware obsoleteness value by the hardware expenditure value, and the software value may be generated by multiplying the software obsoleteness value by the software expenditure value. At step 322, the process obsoleteness value may be multiplied by the process expenditure value to generate a processes value. At step 324, the people obsoleteness value may be multiplied by the people expenditure value to generate a people value. At step 326 the technology value, the processes value, and the people value may be summed to generate the technology index. In certain embodiments, the technology index may be calculated by summing the hardware value, the software value, the process value, and the people value. In certain embodiments, the sum of the technology value (e.g., the hardware value and the software value), the process value, and the people value may be multiplied by one hundred such that the generated technology index is expressed as a percentage.

Although particular methods have been described with reference to FIGS. 2-3, the present invention contemplates any suitable methods in accordance with the present invention. Thus, certain of the steps described with reference to FIGS. 2-3 may take place substantially simultaneously and/or in different orders than as shown and described. Moreover, components of system 10 may use methods with additional steps, fewer steps, and/or different steps, so long as the methods remain appropriate.

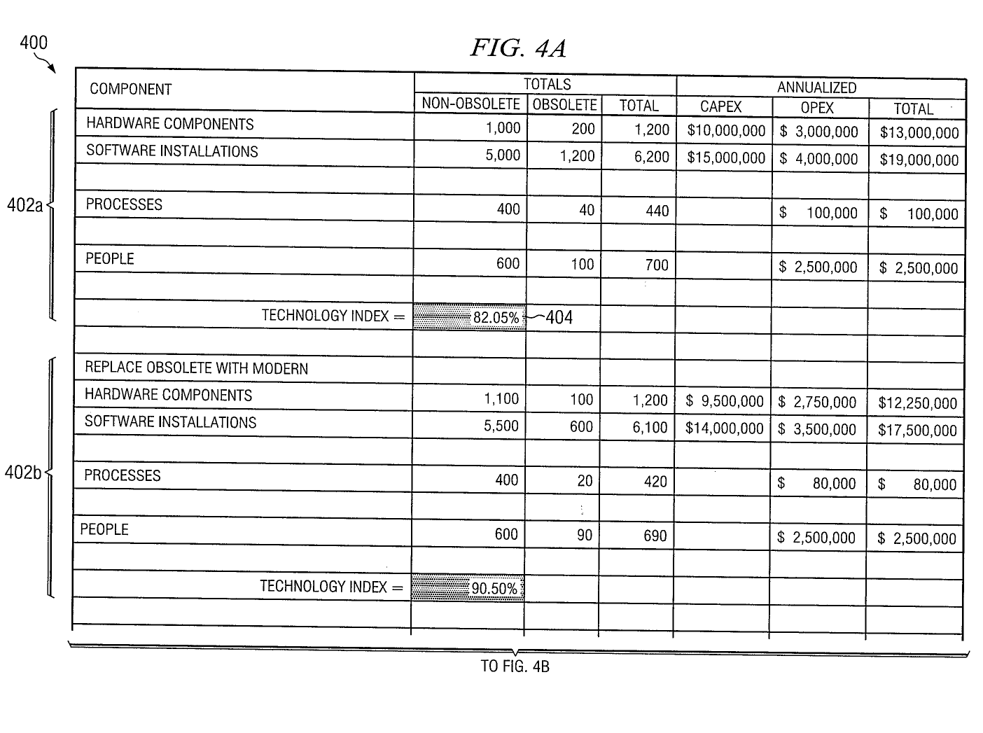

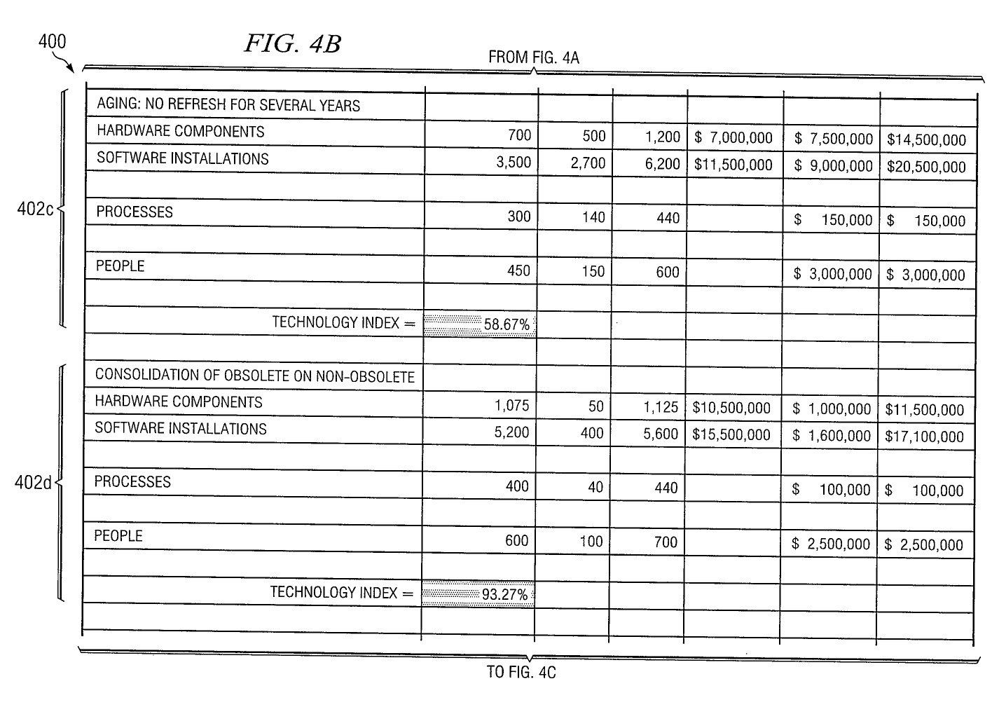

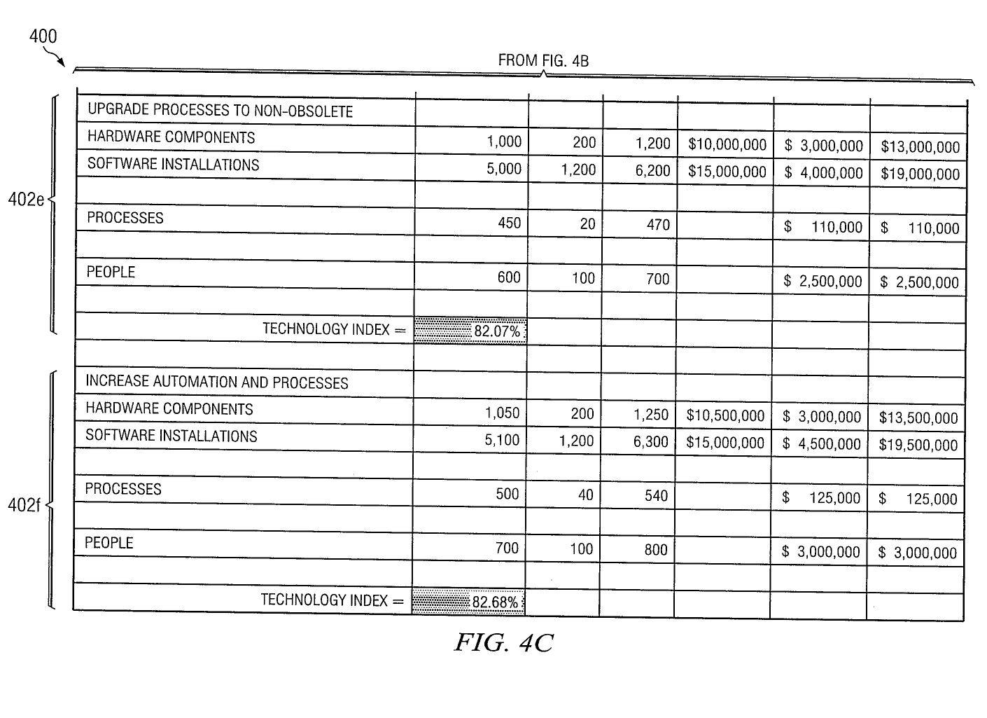

FIGS. 4A-4C illustrates an example spreadsheet 400 that may be generated according to certain embodiments of the present invention. Spreadsheet 400 shows multiple sets of IT quantity data 24 and expenditure data 26, as well as the resulting technology index for each data set. In particular, spreadsheet 400 includes six calculation sets (first calculation set 402a, second calculation set 402b, third calculation set 402c, fourth calculation set 402d, fifth calculation set 402e, and sixth calculation set 402e), each corresponding to a set of IT quantity data 24, expenditure data 26, and the resulting technology index. It should be noted that the contents and arrangement of spreadsheet 400 are for example purposes only and should not be used to limit the present invention.

Each set of IT quantity data 24 in spreadsheet 400 includes an indication of: (1) a number of non-obsolete hardware components, a number of obsolete hardware components, and a total number of hardware components; (2) a number of non-obsolete software installations, a number of obsolete software installations, and a total number of software installations; (3) a number of non-obsolete processes, a number of obsolete processes, and a total number of processes; and (4) a number of non-obsolete people, a number of obsolete people, and a total number of people.

Each set of expenditure data 26 in spreadsheet 400 includes an indication of: (1) capital expenditures for the hardware components, operational expenditures for the hardware components, and total expenditures for the hardware components; (2) capital expenditures for the software installations, operational expenditures for the software installations, and total expenditures for the software installations; (3) operational expenditures for the processes and total expenditures for the processes; and (4) operational expenditures for the people and total expenditures for the people. In this particular example, the expenditure data is annualized.

In certain embodiments, the technology index for first calculation set 402a of spreadsheet is calculated in the following manner: ((1000/1200*$13,000,000/$34,600,000) (5000/6200*$19,000,000/$34,600,000) (400/440*$100,000/$34,600,000) (600/700*$2,500,000/$34,600,000))*100.00=82.05%

This expression of the formula for calculating the technology index for first calculation set 402a is merely for example purposes and should not be used to limit the present invention. In this example, the following values (for first calculation set 402a) correspond to the terminology used throughout this description:

Number of non-obsolete hardware components=1000

Number of obsolete hardware components=200

Total number of hardware components=1200

Number of non-obsolete software installations=5000

Number of obsolete software installations=1200

Total number of software installations=6200

Number of non-obsolete processes=400

Number of obsolete processes=40

Total number of processes=440

Number of non-obsolete people=600

Number of obsolete people=100

Total number of people=700

Hardware obsoleteness value=Number of non-obsolete hardware components/Total number of hardware components

Software obsoleteness value=Number of non-obsolete software components/Total number of software components

Process obsoleteness value=Number of non-obsolete processes/Total number of processes

People obsoleteness value=Number of non-obsolete people/Total number of people

Hardware expenditures=$13,000,000

Software expenditures=$19,000,000

Processes expenditures=$100,000

People expenditures=$2,500,000

Total expenditures (Hardware expenditures+Software expenditures+Processes expenditures+People expenditures)

Hardware expenditure value=Hardware expenditures/Total expenditures

Software expenditure value=Software expenditures/Total expenditures

Process expenditure value=Processes expenditures/Total expenditures

People expenditure value=People expenditures/Total expenditures

Hardware value=Hardware obsoleteness value*Hardware expenditures value

Software value=Software obsoleteness value*Software expenditure value

Processes value=Process obsoleteness value*Process expenditure value

People value=People obsoleteness value*People expenditures value

Technology index=100*(Hardware value+Software value+Processes value+People value)

The technology indices for each of the other calculation sets 402 of spreadsheet 400 may be calculated in a substantially similar manner to that described above with reference to first calculation set 402a.

IT quantity data 24, expenditure data 26, and the resulting technology index shown in cell 404 of spreadsheet 400 (i.e., 82.05%) shown in first calculation set 402a of spreadsheet 400 may be considered a baseline, which may be associated with a first time period for example. Each of the remaining calculation sets 402 of spreadsheet 400 corresponds to a potential change in the IT of the entity. These portions may be associated with a later time period or may reflect a future projection for example.

Table 1 below reflects anticipated impact on the technology index for some example changes in the IT environment of an entity. The example changes provided in Table 1 correspond to the example changes shown in spreadsheet 400 for each of calculation sets 402b through 402f. For example, each row in the following table corresponds to a calculation set 402 of spreadsheet 400. As described above, calculation set 402a of spreadsheet 400 represents a baseline technology index for a first time period. Each of the other calculation sets 402b through 402f of spreadsheet 400 represents a change to the baseline. The other calculations sets 402b through 402f may be associated with subsequent time periods or with future projections, for example. It should be appreciated that the example IT environment changes, descriptions, and technology index impacts shown in Table 1 are merely examples.

TABLE 1

| | | Technology |
|---|---|---|
| IT Environment Change | Description | Index Impact |
| Replace obsolete | Replacement of obsolete | Increase |
| technology with non- | technology with non- | |
| obsolete technology | obsolete technology may | |
| | increase the overall | |
| | currency of the technology | |
| | environment | |
| Aging: No technology | In general, technology | Decrease |
| refresh for several years | refreshes may increase the | |
| | amount of current (or non- | |
| | obsolete) technology. As a | |
| | result, if no refreshes are | |
| | performed, technology | |
| | obsolescence may | |
| | increase. | |
| Consolidation of obsolete | If obsolete hardware and | Increase |
| and non-obsolete | software is replaced with | |
| technology | non-obsolete hardware and | |
| | software, in general, the | |
| | overall technology | |
| | currency may increase. | |
| Upgrade processes to non- | If only processes are | Increase |
| obsolete | changes to reflect non- | |
| | obsolete technology, the | |
| | overall technology | |
| | currency may increase. | |
| Increase processes and | If automation is used to | Increase |
| automation | manage the overall IT | |
| | environment, technology | |
| | currency may increase, as | |
| | more current technology | |
| | (e.g., hardware, software, | |
| | processes, and people | |
| | skill-sets) are used. | |

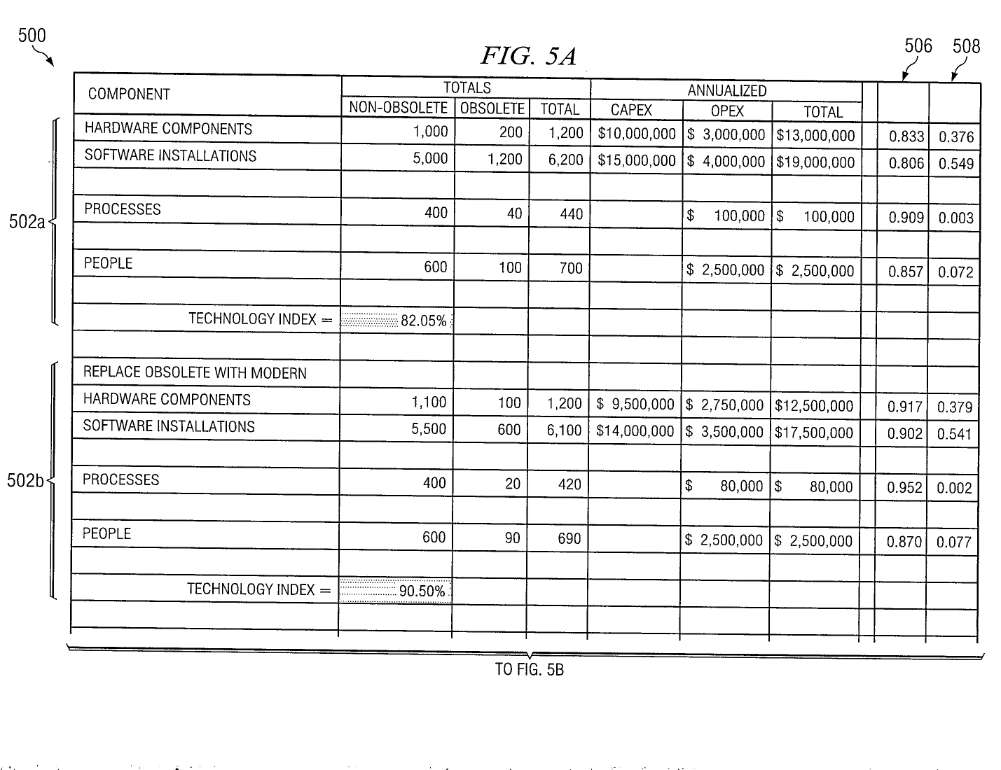

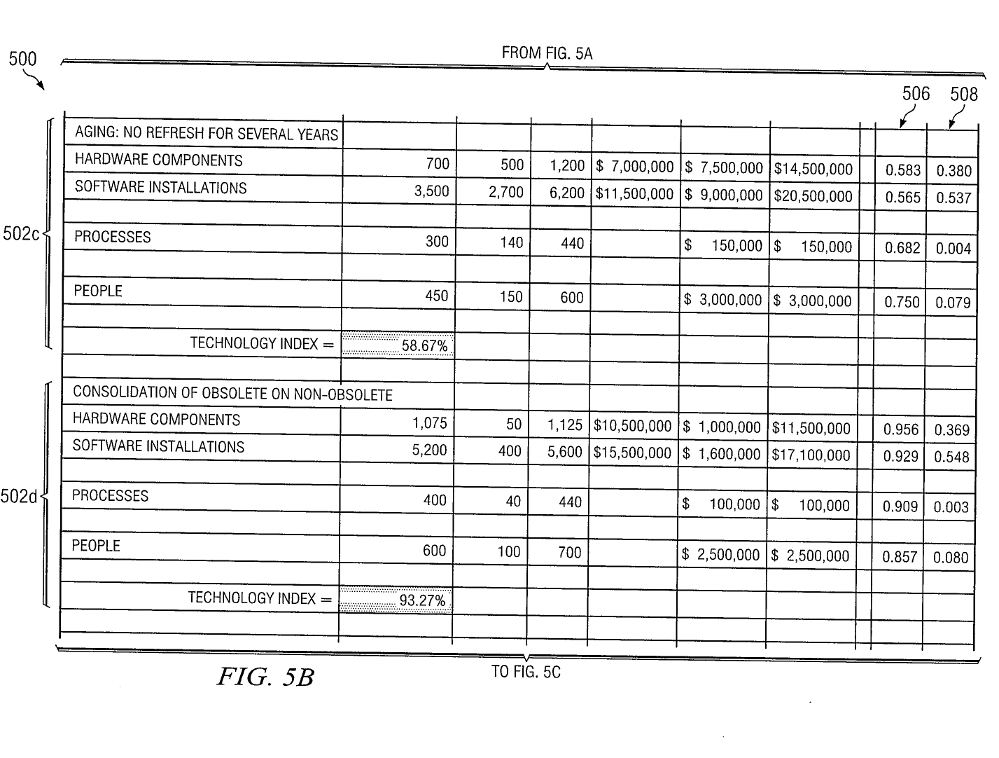

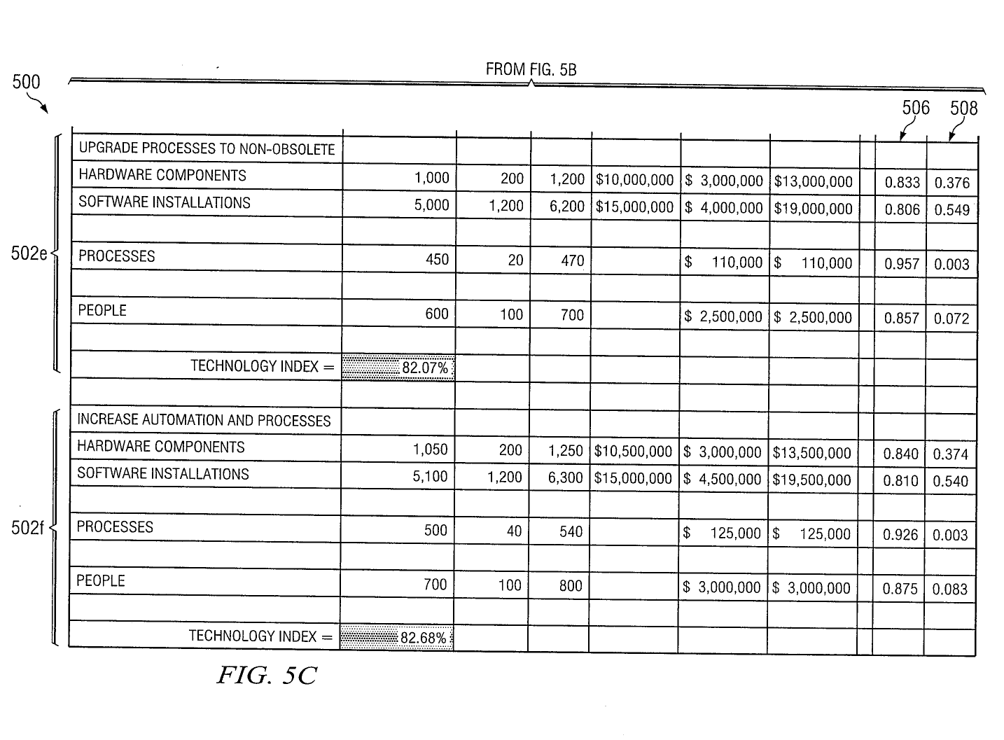

FIGS. 5A-5C illustrates the example spreadsheet of FIGS. 4A-4C in greater detail. In particular, spreadsheet 500 illustrated in FIGS. 5A-5C includes columns 506 and 508 of intermediate values (i.e., the hardware obsoleteness value, the hardware expenditure value, the software obsoleteness value, the software expenditure value, the process obsoleteness value, the process expenditure value, the people obsoleteness value, and the people expenditure value) that may be calculated in order to calculate the technology index.

Assuming that the six columns of spreadsheet 500 correspond to the letters A, B, C, D, E, F, G, H, I, and J, respectively, and that the rows of spreadsheet 500 (including the header, which spans two rows of spreadsheet 500) correspond to the numbers 1, 2, 3, and so on, then in certain embodiments the following formula may be programmed into a spreadsheet application to calculate the technology index for calculation set 502a:

hardware obsoleteness value (I3)=B3/D3

software obsoleteness value (I4)=B4/D4

process obsoleteness value (I6)=B6/D6

people obsoleteness value (I8)=B8/D8

hardware expenditure value (J3)=G3/(G3+G4+G6+G8)

software expenditure value (J4)=G4/(G3+G4+G6+G8)

process expenditure value (J6)=G6/(G3+G4+G6+G8)

people expenditure value (J8)=G8/(G3+G4+G6+G8)

technology index (B10)=((I3)(J3)+(I4)(J4)+(I6)(J6)+(I8)(J8))*100

The intermediate values and technology index for each of the other calculation sets 502 of spreadsheet 500 may be generated in a substantially similar manner.

Although the present invention has been described with several embodiments, diverse changes, substitutions, variations, alterations, and modifications may be suggested to one skilled in the art, and it is intended that the invention encompass all such changes, substitutions, variations, alterations, and modifications as fall within the spirit and scope of the appended claims.

What is claimed is:

1. A method for determining a technology state of an entity, comprising:
accessing information technology (IT) quantity data for an entity for a first time period, the IT quantity data comprising:
technology quantity data for one or more technology components of the entity, the technology quantity data indicating for the first time period a number of obsolete technology components of the entity and a number of non-obsolete technology components of the entity;
process quantity data for one or more processes of the entity, the process quantity data indicating for the first time period a number of obsolete processes of the entity and a number of non-obsolete processes of the entity;
people quantity data for one or more people of the entity, the people quantity data indicating for the first time period a number of obsolete people of the entity and a number of non-obsolete people of the entity;
accessing expenditure data for the one or more technology components, the one or more processes, and the one or more people of the entity, the expenditure data comprising one or more of capital expense data and operational expense data for the first time period;
generating, according to the IT quantity data and the expenditure data, a technology index for the entity that quantifies a technology state for the entity.

2. The method of claim 1, wherein generating the technology index comprises:
determining for the first time period a technology obsoleteness value, a process obsoleteness value, and a people obsoleteness value;
determining for the first time period a technology expenditure value, a process expenditure value, and a people expenditure value;
multiplying the technology obsoleteness value by the technology expenditure value to generate a technology value for the first time period;
multiplying the process obsoleteness value by the process expenditure value to generate a processes value for the first time period;
multiplying the people obsoleteness value by the people expenditure value to generate a people value for the first time period; and
summing the technology value, the processes value, and the people value to generate the technology index.

3. The method of claim 2, further comprising multiplying the sum of the technology value, the processes value, and the people value by one hundred such that the generated technology index is expressed as a percentage.

4. The method of claim 2, comprising:
determining the technology obsoleteness value by dividing the number of non-obsolete technology components by a total number of technology components, the total number of technology components comprising a sum of the number of non-obsolete and obsolete technology components;
determining the process obsoleteness value by dividing the number of non-obsolete processes by a total number of processes of the entity, the total number of processes comprising a sum of the number of non-obsolete and obsolete processes; and
determining the people obsoleteness value by dividing the number of non-obsolete people by a total number of people of the entity, the total number of people comprising a sum of the number of non-obsolete and obsolete people.

5. The method of claim 2, comprising:
determining technology expenditures for the first time period by summing capital expenditures and operational expenditures for the one or more technology components for the first time period;
equating processes expenditures for the first time period to operational expenditures for the one or more processes for the first time period;
equating people expenditures for the first time period to operational expenditures for the one or more people for the first time period;
determining total expenditures for the first time period by summing the technology expenditures, the processes expenditures, and the people expenditures for the first time period;
determining the technology expenditure value for the first time period by dividing the technology expenditures by the total expenditures for the entity for the first time period;
determining the process expenditure value for the first time period by dividing the processes expenditures by the total expenditures for the entity for the first time period; and
determining the people expenditure value for the first time period by dividing the people expenditures by the total expenditures for the entity for the first time period.

6. The method of claim 1, wherein the one or more technology components of the entity comprise one or more hardware components and one or more software installations, the technology quantity data indicating:
a number of obsolete hardware components of the entity;
a number of non-obsolete hardware components of the entity;
a number of obsolete software installations of the entity; and
a number of non-obsolete software installations of the entity.

7. The method of claim 1, wherein:
the generated technology index represents the technology state of the entity for the first time period; and
the method further comprises generating, according to IT quantity data and expenditure data for a second time period, a technology index for the second time period, the relationship between the technology index for the first time period and the technology index for the second time period providing an indication of the change in the technology state for the entity over time.

8. The method of claim 1, further comprising:
determining whether the technology index is less than a predetermined threshold; and
if it is determined that the technology index has a predefined relationship with the predetermined threshold, generating an alert.

9. The method of claim 1, wherein:
the generated technology index represents the technology state of the entity for the first time period; and
the method further comprises generating, according to modified IT quantity data and modified expenditure data, a predictive technology index, the relationship between the technology index for the first time period and the predictive technology index providing an indication of the change in the technology state for the entity based on future modifications to the IT of the entity.

10. The method of claim 1, wherein:
the technology index is greater than or equal to zero and less than or equal to one;
a technology index equal to zero reflects a non-standardized IT environment of obsolete technology; and
a technology index equal to one reflects a standardized IT environment of non-obsolete technology.

11. The method of claim 1, wherein:
the obsolete processes comprise the processes associated with the obsolete technology components;
the non-obsolete processes comprise the processes associated with the non-obsolete technology components;
the obsolete people comprise the people associated with the obsolete technology components; and
the non-obsolete people comprise the people associated with the non-obsolete technology components.

12. A system for determining a technology state of an entity, comprising:
a memory module operable to store:
information technology (IT) quantity data for an entity for a first time period, the IT quantity data comprising:
technology quantity data for one or more technology components of the entity, the technology quantity data indicating for the first time period a number of obsolete technology components of the entity and a number of non-obsolete technology components of the entity;
process quantity data for one or more processes of the entity, the process quantity data indicating for the first time period a number of obsolete processes of the entity and a number of non-obsolete processes of the entity; and
people quantity data for one or more people of the entity, the people quantity data indicating for the first time period a number of obsolete people of the entity and a number of non-obsolete people of the entity; and
expenditure data for the one or more technology components, the one or more processes, and the one or more people of the entity, the expenditure data comprising one or more of capital expense data and operational expense data for the first time period;
one or more processing units operable to generate, according to the IT quantity data and the expenditure data, a technology index for the entity that quantifies a technology state for the entity.

13. The system of claim 12, wherein the one or more processing units are operable to generate the technology index by:
determining for the first time period a technology obsoleteness value, a process obsoleteness value, and a people obsoleteness value;
determining for the first time period a technology expenditure value, a process expenditure value, and a people expenditure value;
multiplying the technology obsoleteness value by the technology expenditure value to generate a technology value for the first time period;
multiplying the process obsoleteness value by the process expenditure value to generate a processes value for the first time period;
multiplying the people obsoleteness value by the people expenditure value to generate a people value for the first time period; and
summing the technology value, the processes value, and the people value to generate the technology index.

14. The system of claim 13, wherein the one or more processing units are further operable to multiply the sum of the technology value, the processes value, and the people value by one hundred such that the generated technology index is expressed as a percentage.

15. The system of claim 13, wherein the one or more processing units are operable to:
determine the technology obsoleteness value by dividing the number of non-obsolete technology components by a total number of technology components, the total number of technology components comprising a sum of the number of non-obsolete and obsolete technology components;
determine the process obsoleteness value by dividing the number of non-obsolete processes by a total number of processes of the entity, the total number of processes comprising a sum of the number of non-obsolete and obsolete processes; and
determine the people obsoleteness value by dividing the number of non-obsolete people by a total number of people of the entity, the total number of people comprising a sum of the number of non-obsolete and obsolete people.

16. The system of claim 13, wherein the one or more processing units are operable to:
determine technology expenditures for the first time period by summing capital expenditures and operational expenditures for the one or more technology components for the first time period;
equate processes expenditures for the first time period to operational expenditures for the one or more processes for the first time period;
equate people expenditures for the first time period to operational expenditures for the one or more people for the first time period;
determine total expenditures for the first time period by summing the technology expenditures, the processes expenditures, and the people expenditures for the first time period;
determine the technology expenditure value for the first time period by dividing the technology expenditures by the total expenditures for the entity for the first time period;
determine the process expenditure value for the first time period by dividing the processes expenditures by the total expenditures for the entity for the first time period; and
determine the people expenditure value for the first time period by dividing the people expenditures by the total expenditures for the entity for the first time period.

17. The system of claim 12, wherein the one or more technology components of the entity comprise one or more hardware components and one or more software installations, the technology quantity data indicating:
a number of obsolete hardware components of the entity;
a number of non-obsolete hardware components of the entity;
a number of obsolete software installations of the entity; and
a number of non-obsolete software installations of the entity.

18. The system of claim 12, wherein:
the generated technology index represents the technology state of the entity for the first time period; and
the one or more processing units are further operable to generate, according to IT quantity data and expenditure data for a second time period, a technology index for the second time period, the relationship between the technology index for the first time period and the technology index for the second time period providing an indication of the change in the technology state for the entity over time.

19. The system of claim 12, wherein the one or more processing units are further operable to:
determine whether the technology index is less than a predetermined threshold; and
if it is determined that the technology index has a predefined relationship with the predetermined threshold, generate an alert.

20. The system of claim 12, wherein:
the generated technology index represents the technology state of the entity for the first time period; and
the one or more processing units are further operable to generate, according to modified IT quantity data and modified expenditure data, a predictive technology index, the relationship between the technology index for the first time period and the predictive technology index providing an indication of the change in the technology state for the entity based on future modifications to the IT of the entity.

21. The system of claim 12, wherein:
the technology index is greater than or equal to zero and less than or equal to one;
a technology index equal to zero reflects a non-standardized IT environment of obsolete technology; and
a technology index equal to one reflects a standardized IT environment of non-obsolete technology.

22. The system of claim 12, wherein:
the obsolete processes comprise the processes associated with the obsolete technology components;
the non-obsolete processes comprise the processes associated with the non-obsolete technology components;
the obsolete people comprise the people associated with the obsolete technology components; and
the non-obsolete people comprise the people associated with the non-obsolete technology components.

23. Software for determining a technology state of an entity, the software being embodied in a computer-readable medium and when executed operable to:
access information technology (IT) quantity data for an entity for a first time period, the IT quantity data comprising:
technology quantity data for one or more technology components of the entity, the technology quantity data indicating for the first time period a number of obsolete technology components of the entity and a number of non-obsolete technology components of the entity;
process quantity data for one or more processes of the entity, the process quantity data indicating for the first time period a number of obsolete processes of the entity and a number of non-obsolete processes of the entity;
people quantity data for one or more people of the entity, the people quantity data indicating for the first time period a number of obsolete people of the entity and a number of non-obsolete people of the entity;
access expenditure data for the one or more technology components, the one or more processes, and the one or more people of the entity, the expenditure data comprising one or more of capital expense data and operational expense data for the first time period;
generate, according to the IT quantity data and the expenditure data, a technology index for the entity that quantifies a technology state for the entity.

24. The software of claim 23, operable to generate the technology index by:
determining for the first time period a technology obsoleteness value, a process obsoleteness value, and a people obsoleteness value;
determining for the first time period a technology expenditure value, a process expenditure value, and a people expenditure value;
multiplying the technology obsoleteness value by the technology expenditure value to generate a technology value for the first time period;
multiplying the process obsoleteness value by the process expenditure value to generate a processes value for the first time period;
multiplying the people obsoleteness value by the people expenditure value to generate a people value for the first time period; and
summing the technology value, the processes value, and the people value to generate the technology index.

25. The software of claim 24, further operable to multiply the sum of the technology value, the processes value, and the people value by one hundred such that the generated technology index is expressed as a percentage.

26. The software of claim 24, operable to:
determine the technology obsoleteness value by dividing the number of non-obsolete technology components by a total number of technology components, the total number of technology components comprising a sum of the number of non-obsolete and obsolete technology components;
determine the process obsoleteness value by dividing the number of non-obsolete processes by a total number of processes of the entity, the total number of processes comprising a sum of the number of non-obsolete and obsolete processes; and
determine the people obsoleteness value by dividing the number of non-obsolete people by a total number of people of the entity, the total number of people comprising a sum of the number of non-obsolete and obsolete people.

27. The software of claim 24, operable to:
determine technology expenditures for the first time period by summing capital expenditures and operational expenditures for the one or more technology components for the first time period;
equate processes expenditures for the first time period to operational expenditures for the one or more processes for the first time period;
equate people expenditures for the first time period to operational expenditures for the one or more people for the first time period;
determine total expenditures for the first time period by summing the technology expenditures, the processes expenditures, and the people expenditures for the first time period;
determine the technology expenditure value for the first time period by dividing the technology expenditures by the total expenditures for the entity for the first time period;
determine the process expenditure value for the first time period by dividing the processes expenditures by the total expenditures for the entity for the first time period; and
determine the people expenditure value for the first time period by dividing the people expenditures by the total expenditures for the entity for the first time period.

28. The software of claim 23, wherein the one or more technology components of the entity comprise one or more hardware components and one or more software installations, the technology quantity data indicating:
a number of obsolete hardware components of the entity;
a number of non-obsolete hardware components of the entity;
a number of obsolete software installations of the entity; and
a number of non-obsolete software installations of the entity.

29. The software of claim 23, wherein:
the generated technology index represents the technology state of the entity for the first time period; and
the software is further operable to generate, according to IT quantity data and expenditure data for a second time period, a technology index for the second time period, the relationship between the technology index for the first time period and the technology index for the second time period providing an indication of the change in the technology state for the entity over time.

30. The software of claim 23, further operable to:
determine whether the technology index is less than a predetermined threshold; and
if it is determined that the technology index has a predefined relationship with the predetermined threshold, generate an alert.

31. The software of claim 23, wherein:
the generated technology index represents the technology state of the entity for the first time period; and
the software is further operable to generate, according to modified IT quantity data and modified expenditure data, a predictive technology index, the relationship between the technology index for the first time period and the predictive technology index providing an indication of the change in the technology state for the entity based on future modifications to the IT of the entity.

32. The software of claim 23, wherein:
the technology index is greater than or equal to zero and less than or equal to one;
a technology index equal to zero reflects a non-standardized IT environment of obsolete technology; and
a technology index equal to one reflects a standardized IT environment of non-obsolete technology.

33. The software of claim 23, wherein:
the obsolete processes comprise the processes associated with the obsolete technology components;
the non-obsolete processes comprise the processes associated with the non-obsolete technology components;
the obsolete people comprise the people associated with the obsolete technology components; and
the non-obsolete people comprise the people associated with the non-obsolete technology components.

34. A method for determining a technology state of an entity, the entity having a number of non-obsolete and obsolete hardware components, software installations, processes, and people, the method comprising:
determining a hardware obsoleteness value for a first time period by dividing the number of non-obsolete hardware components by a total number of hardware components;
determining a software obsoleteness value for the first time period by dividing a number of non-obsolete software installations by a total number of software installations;
determining a process obsoleteness value for the first time period by dividing a number of non-obsolete processes by a total number of processes of the entity;
determining a people obsoleteness value for the first time period by dividing a number of non-obsolete people by a total number of people of the entity;
determining hardware expenditures for the first time period by summing capital expenditures and operational expenditures for the first time period for the hardware components of the entity;
determining software expenditures for the first time period by summing capital expenditures and operational expenditures for the first time period for the software components of the entity;
determining process expenditures for the first time period by equating the process expenditures to operational expenditures for the processes of the entity;
determining people expenditures for the first time period by equating the people expenditures to operational expenditures for the people of the entity;
determining total expenditures for the entity for the first time period by summing the hardware expenditures, software expenditures, process expenditures, and people expenditures for the first time period;
determining a hardware expenditure value for the first time period by dividing the hardware expenditures by the total expenditures for the entity;
determining a software expenditure value for the first time period by dividing the software expenditures by the total expenditures for the entity;
determining a process expenditure value for the first time period by dividing the processes expenditures by the total expenditures for the entity;
determining a people expenditure value for the first time period by dividing the people expenditures by the total expenditures for the entity;
multiplying the hardware obsoleteness value by the hardware expenditure value to generate a hardware value;
multiplying the software obsoleteness value by the software expenditure value to generate a software value;
multiplying the process obsoleteness value by the process expenditure value to generate a processes value;
multiplying the people obsoleteness value by the people expenditure value to generate a people value; and
summing the hardware value, the software value, the processes value, and the people value to generate a technology index.

35. The method of claim 34, further comprising multiplying the sum of the hardware value, the software value, the processes value, and the people value by one hundred such that the generated technology index is expressed as a percentage.
